(19) United States
(12) Patent Application Publication
(10) Pub. No.: US 2005/0216365 A1
(43) Pub. Date: Sep. 29, 2005

(54) Exchange system

(75) Inventor: Kevin Lagge, Edmond, OK (US)

Correspondence Address: DUNLAP, CODDING & ROGERS P.C., PO BOX 16370, OKLAHOMA CITY, OK, 73113, US

(73) Assignee: MainStreet Exchange

(21) Appl. No.: 11/068,631

(22) Filed: Feb. 28, 2005

Related U.S. Application Data
(60) Provisional application No. 60/548,996, filed on Mar. 1, 2004.

(51) Int. Cl. G06F 17/60

(52) U.S. Cl. 705/27

(57) ABSTRACT

An exchange system for managing the buying and selling of goods and services between registered buyers and registered sellers. The exchange system includes a host system, a plurality of shop systems and a plurality of supplier systems. The host system is capable of selectively receiving, storing, and transmitting information representative of buying and selling of the goods and services. The plurality of shop systems is remotely located from the host system and in communication with the host system. Each of the plurality of shop systems is associated with a registered buyer and is capable of inputting a request for quotation into the host system. The plurality of supplier systems is remotely located from the host system and in communication with the host system. Each of the plurality of supplier systems is associated with a registered seller and receives the request for quotation on the registered seller's behalf.

### CROSS-REFERENCE TO RELATED APPLICATIONS

This application claims the benefit under 35 U.S.C. 119(e) of U.S. Provisional Application Ser. No. 60/548,996, filed Mar. 1, 2004, the contents of which are hereby expressly incorporated by reference herein in its entirety.

### STATEMENT REGARDING FEDERALLY SPONSORED RESEARCH OR DEVELOPMENT

Not Applicable.

### BRIEF DESCRIPTION OF THE SEVERAL VIEWS OF THE DRAWINGS

FIG. 1 is a schematic representation of an exchange system constructed in accordance with the present invention.

FIG. 2a is a website data entry screen for inputting data to create a request for quote for a needed part.

FIG. 2b is a website data entry screen for identifying the type of needed part.

FIG. 2c is a website data entry screen for inputting data to create a quote for the part submitted.

FIG. 2d is a website data entry screen for inputting data to ask a question of a shop system.

FIG. 2e is a website screen for accepting a quote for the part type.

FIG. 2f is a website data entry screen for inputting data to ask a supplier system a question.

FIG. 2g is a website data entry screen for returning a part.

### DETAILED DESCRIPTION OF THE INVENTION

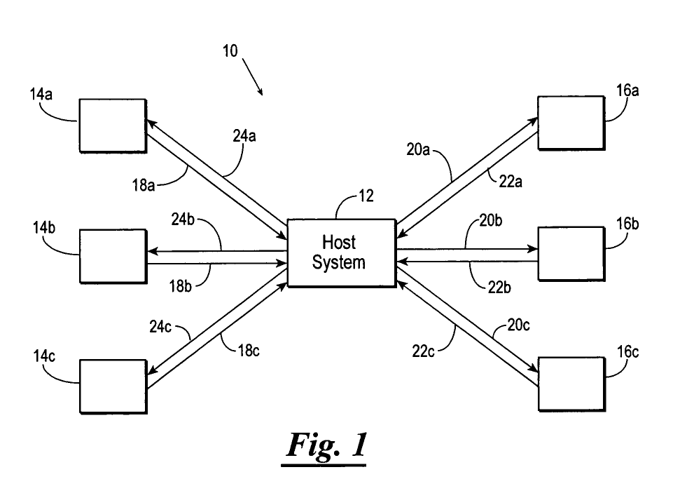

Referring to FIG. 1, shown therein and designated by reference numeral 10 is an exchange system constructed in accordance with the present invention. The exchange system 10 manages the buying and selling of goods and services between registered buyers and sellers. The exchange system 10 is preferably established as a web-site on a public network, such as the Internet or the World Wide Web. The exchange system 10 is preferably used to manage the buying and selling of automotive parts; however, it should be understood that the exchange system 10 could be used for managing the buying and selling of other various parts and services in plumbing, housing, computers, or the like.

In general, the exchange system 10 is provided with a host system 12, a plurality of shop systems 14 (labeled in FIG. 1 via the reference numerals 14a, 14b, and 14c for purposes of clarity), and a plurality of supplier systems 16 (labeled in FIG. 1 via the reference numerals 16a, 16b, and 16c for purposes of clarity).

The host system 12 is capable of selectively receiving, storing, and transmitting information representative of buying and selling of the goods and services between registered buyers and sellers of the shop systems 14 and the supplier systems 16.

The shop systems 14 are associated with registered buyers. The shop systems 14 are remotely located from the host system 12 and in communication with the host system 12 via a signal path 18 (18a, 18b, 18c). In one preferred embodiment, each registered buyer(s) is given a user name(s) and a password(s) so the shop system 14 may identify itself as an authorized user. Once the shop system 14 logs into the host system 12, the shop system 14 is capable of inputting or selecting a list of registered sellers. The shop system 14 also inputs a request for quotation (RFQ) into the host system 12. The host system 12 assigns the RFQ a unique tracking code which enables the host system 12 to store and transmit the RFQ to the sellers identified in the list of registered sellers inputted or selected by the registered buyer using the shop system 14. The RFQ includes specifications or information describing the desired good or service that the registered buyer of the shop system 14 is interested in purchasing.

When the exchange system 10 is used for selling automotive parts, the RFQ includes at least one or more of a year, a make, a model, an engine, a transmission, and a vehicle identification number (VIN) of an automotive vehicle. The RFQ also includes an automotive part type, a quantity of the automotive part, and a part description. Once the RFQ is submitted, the registered buyer using the shop system 14 can input a cancellation order into the host system 12 to cancel the RFQ.

The supplier systems 16 are associated with registered sellers. The supplier systems 16 are remotely located from and in communication with the host system 12 by signal paths 20a, 20b, and 20c. Desirably, registered sellers are given a user name and a password to access the host system 12 via the supplier systems 16.

In one preferred embodiment, when an RFQ is submitted by one of the shop systems 14, the host system 12 delivers a notification that an RFQ has been submitted to the supplier systems 16 associated with the list of registered sellers. For example, the notification may be communicated to the supplier systems 16 in the form of a pop-up screen when the supplier system 16 logs into the host system 12. The host system 12 can also transmit a notification to the registered sellers by a notification system separate from the supplier system 16. For example, the host system 12 can provide notification of the RFQ to the registered seller(s) of the supplier systems 16 by at least one or more of electronic mail, phone, fax, numeric pager, text messaging, and wireless phone. The manner in which the registered sellers of the supplier systems 16 are notified are preferably specified by each registered seller. For example, one registered seller may choose to be notified of an RFQ by text messaging, and another registered seller may choose to be notified of the RFQ by numeric pager. The supplier system 16 receives the RFQ and then outputs the RFQ in a format perceivable by the registered seller associated with the supplier system 16. For example, the supplier system 16 can be provided with a monitor so that the registered seller can view the RFQ, or a printer so that the registered seller can make a hard copy of the RFQ. The registered seller then enters a quotation into the supplier system 16 and then, upon activation, the supplier system 16 submits or transmits the quotation via a signal path 22 (22a, 22b, 22c) to the host system 12.

Once the quotation is received by the host system 12, the host system 12 desirably notifies the registered buyer in a similar manner to the way in which the registered suppliers are notified. For example, the host system 12 can send a signal to the shop system 14 associated with the registered buyer, or to a separate system, such as mobile phone. The host system 12 stores and transmits the quotation via a signal path 24 (three signal paths 24a, 24b, and 24c being shown in FIG. 1 for purposes of clarity) to the shop system 14.

The quotation created by the registered seller using the supplier system 16 includes specifications, pricing information and/or delivery terms or time for performance terms regarding the subject matter recited in the RFQ. When the RFQ is for an automotive part, the quotation created by the supplier system 16 desirably includes a supplier part number, a brand, a list price, a cost, a core charge, a delivery time, and a warranty. The registered seller using the supplier system 16 can enter a retraction of the quotation into the supplier system 16 and communicate such retraction to the host system 12. The retraction may or may not be accepted by the host system 12 depending on whether or not the quotation has been accepted by the registered buyer who issued the RFQ using the shop system 14.

The host system 12 receives the quotations submitted by the registered sellers who responded to the RFQ, and communicates such quotations to the shop system(s) 14 associated with the registered buyer who submitted the RFQ. The shop system 14 outputs the quotations in a manner perceivable by the registered buyer. For example, the quotations can be output in a visual, audio or hard copy format.

The registered buyer using the shop system 14 reviews the quotations and has the ability to accept one or more of the quotations by entering an acceptance code into the shop system 14. The acceptance code is transmitted to the host system 12 and stored by the host system 12. A notification is then sent to the supplier system 16 associated with the registered seller whose quotation was accepted.

If one of the quotations is accepted, then the registered buyer associated with the shop system 14 must purchase the part or service. When the shop system 14 enters the acceptance code, this in effect places an order with the supplier system 16. The acceptance code preferably includes a purchase order number, which can then be used by the registered seller to bill the registered buyer associated with the shop system 14.

The part or service can be purchased in any suitable manner, such as by charging the cost of the part to the registered buyer's account or the registered buyer can enter their credit card information into the host system 12. The shop system 14 is capable of notifying the supplier system 16 through the host system 12 if it wishes to return a part. The part could be a core part or an unused part.

The signal paths 18, 20, 22, and 24 can be either manual signal paths, or electronic communication signal paths. The electronic communication signal paths can be logical and/or physical links between various software and/or hardware utilized to implement the present invention. The physical links could be air-way or cable communication links. When the invention is implemented, the signal paths may not be separate signal paths but may be a single signal path or multiple signal paths. In addition, it should be understood that the various information does not always have to flow between the components of the present invention in the exact manner shown provided the information is generated and received to accomplish the purposes set forth herein.

As will be understood by one skilled in the art, the shop systems 14 and the supplier systems 16 may have multiple registered buyers or sellers, such as managers and workers, communicating with the host system 12. More than one shop system 14 or supplier system 16 can be associated with one account, and more than one registered buyer or seller can be associated with the account. For example, a car dealership may register with the host system 12 as one “account.” The car dealership's account would have a manager user capable of setting up and maintaining one or more registered buyer accounts. The registered buyer accounts would be set up so that individuals associated with the dealership's shop can log in to the host system 12 and submit RFQs.

In addition, administrators of the host system 12 and sales representatives of the host system 12 may also communicate with the host system 12. Preferably, the host system 12 is established as a website and capable of communicating with a variety of different types of devices utilizing the Internet. This makes the host system 12 available over a very wide geographic area.

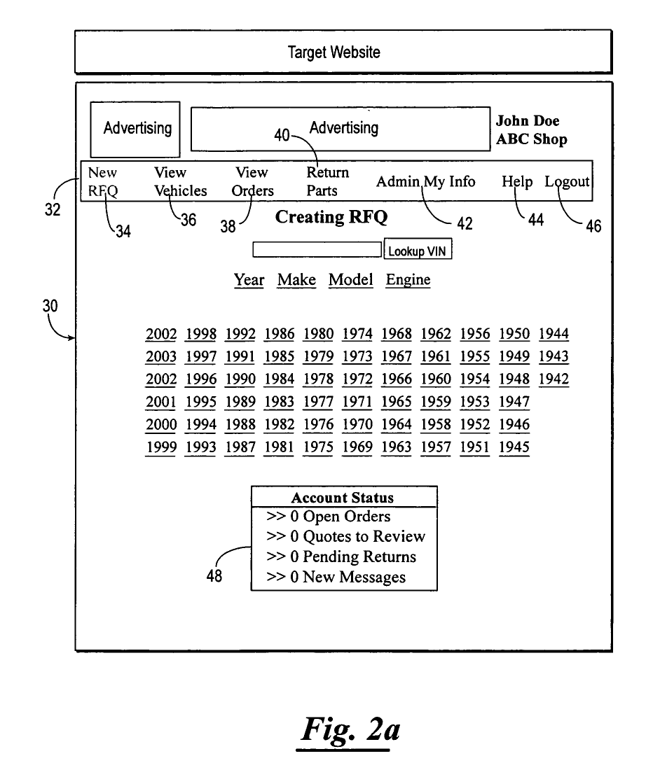

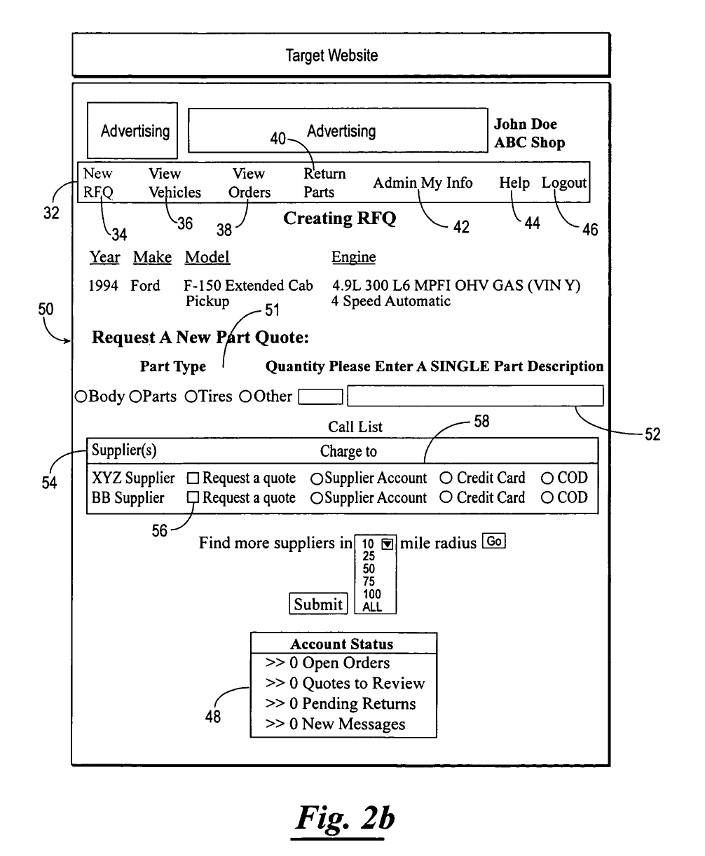

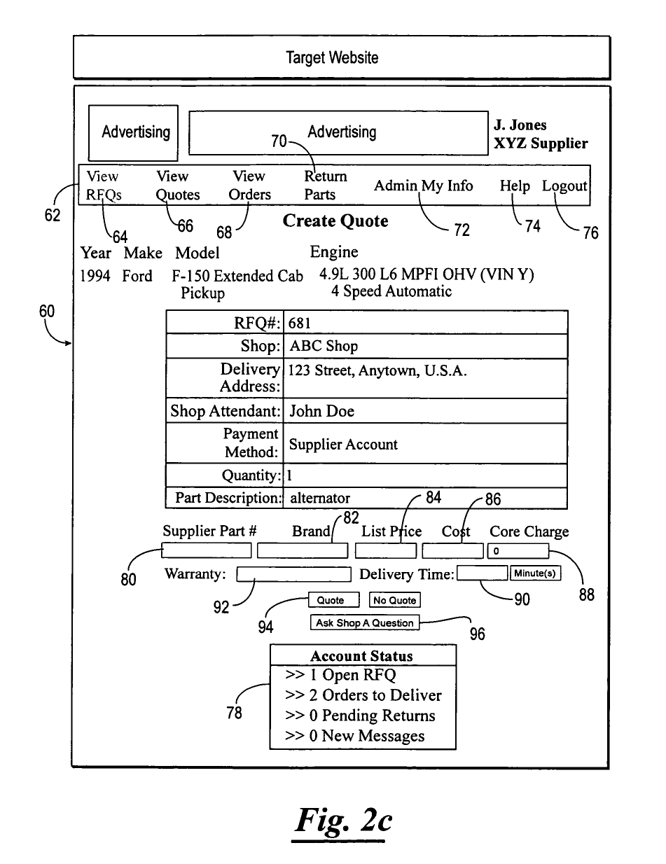

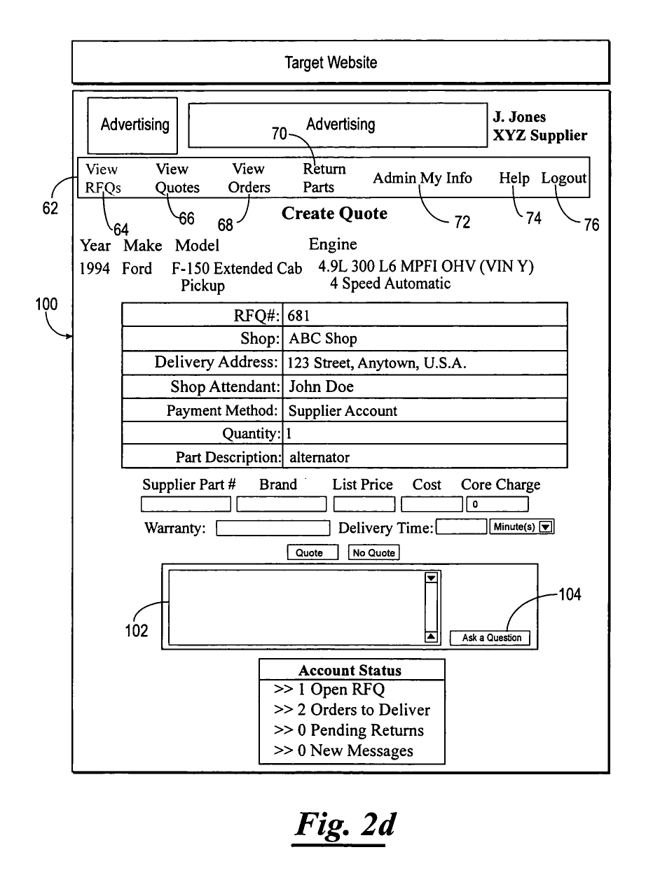

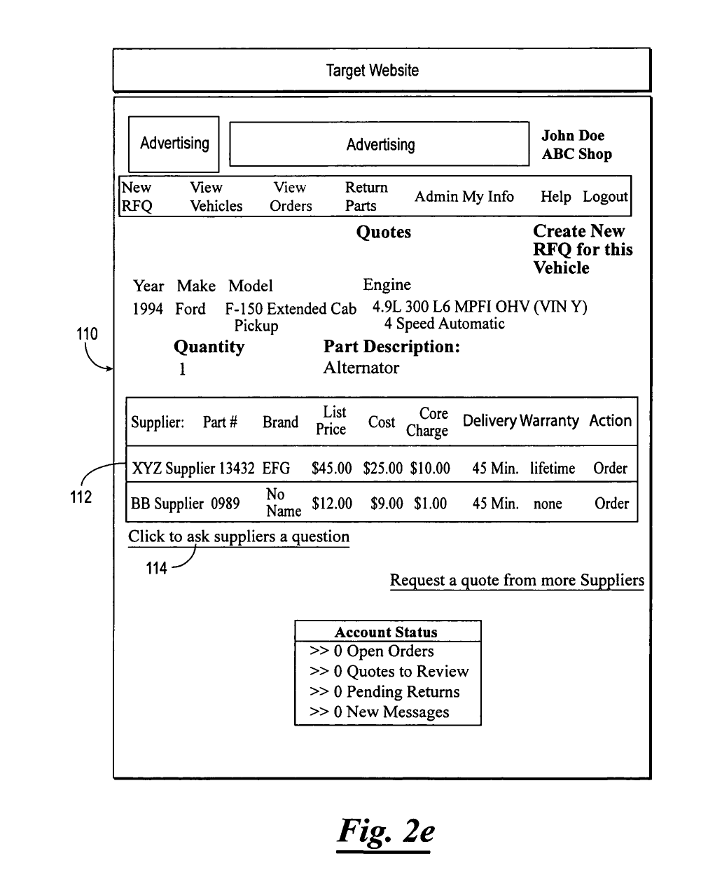

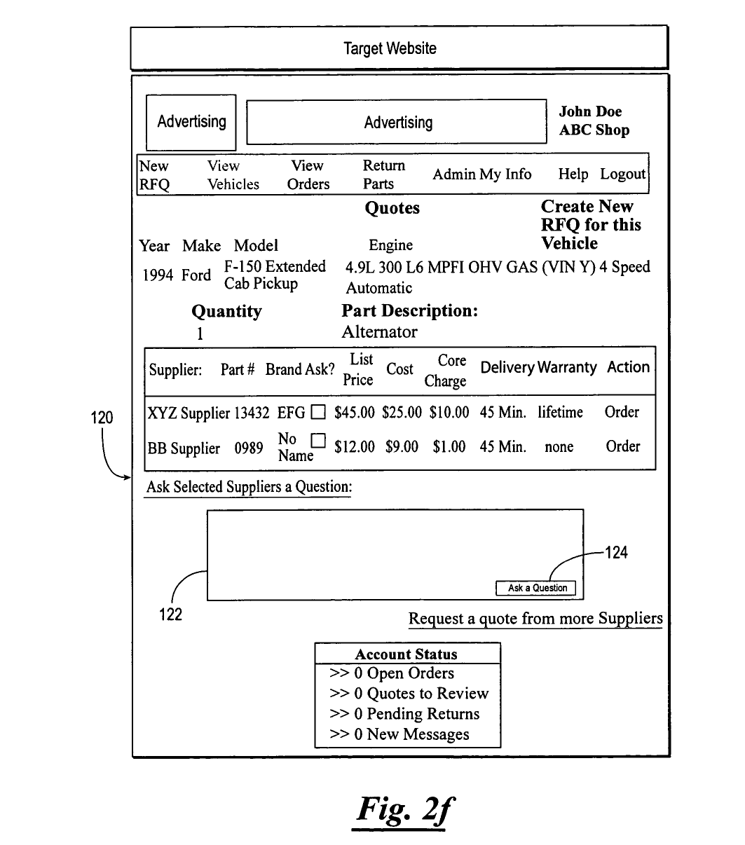

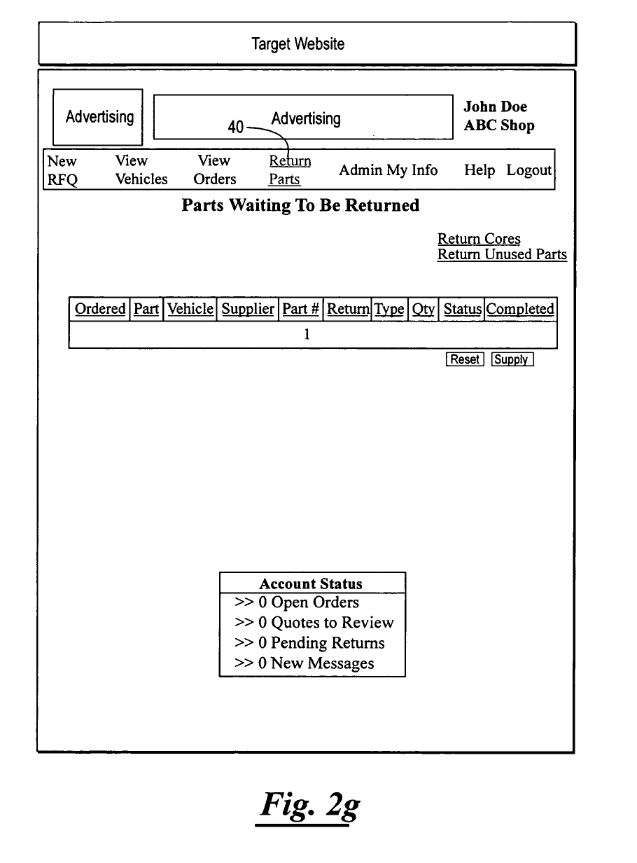

For example, the website requires the shop system 14 and the supplier system 16 to register on the website. Each shop and supplier user is provided with a user name and password before entering or viewing information provided on the website. Thus, the shop system 14 and the supplier system 16 may be provided with multiple user names and passwords. In one embodiment, the website is provided for the buying and selling of car parts between registered shop users and supplier users. Referring to FIG. 2a, an entry screen 30 constructed in accordance with the present invention is shown. The entry screen 30 is an example of a data entry screen as presented on the website for a shop user to create an RFQ. The entry screen 30 is provided with a screen tool bar 32 divided into various sections. A “New RFQ” section 34 creates a new RFQ. A “View Vehicles” section 36 displays the RFQs that have been entered for each vehicle. A “View Orders” section 38 displays the orders that have been placed by the shop user. A “Return Parts” section 40 allows a shop to obtain approval to return defective/unused parts. A “My Info” section 42 displays a shop or supplier user's personal information. The “My Info” section 42 allows the user to update personal information and passwords. A “Help” section 44 provides assistance to the shop user or supplier user in navigating through the website. A “Log Out” section 46 allows the shop user or supplier user to log out of the website system.

The entry screen 30 is provided with an “Account Status” section 48. The “Account Status” section 48 provides the shop user the following types of information: open orders, quotes to review, pending returns, new messages, and the like.

Further, the entry screen 30 is provided with an “Advertising” section 49. The “Advertising” section 49 provides an advertiser the ability to target customers. The website is programmed with the physical location of the advertiser and information regarding the physical location of various customers. The website is programmed to determine which selected customers fall within a particular spatial range from the advertiser's location, thus eliminating the customers that fall outside the spatial range selected. Thus, for example, a shop user is capable of targeting a group of suppliers only within a 2.5 mile radius from the shop user's location. Once the selected supplier within the 2.5 mile radius logs into the website, the supplier receives the advertisement. Any suppliers located outside of the 2.5 mile radius does not receive the advertisement. The rate the advertiser pays is dependent on various elements, such as the spatial range or size of the advertisement selected.

The website entry screen 30 allows the shop user to create the RFQ. The RFQ documents the type of vehicle and the parts requested to repair a vehicle. To create an RFQ, the shop user must identify in the system the type of vehicle that requires a part. The following options may be used to identify the type of vehicle: the year, make, model, engine, or VIN number of the vehicle that needs a part. Referring to FIG. 2b, an entry screen 50 constructed in accordance with the present invention is shown. Once the vehicle type has been identified in the system, the shop user may identify the type of part needed as shown in a “Part Type” Section 51. There are three choices for types of parts: (1) body parts—includes exterior parts of the vehicle (e.g., vendor, door, trunk lid); (2) tires; and (3) other—all other parts (i.e., alternators, starters, spark plugs, etc.). Upon selecting the part type, the shop user enters the quantity of the part needed and provides a description of the part in a description section 52. The system only allows for one part to be entered at a time. This enables different suppliers to quote on different parts. After submitting the part to a supplier, the system allows for additional parts to be submitted for the same vehicle. After entering the part description, the shop user identifies the suppliers to receive the RFQ. If the supplier is a preferred supplier, the name will appear under a “Call List” section 54. In order to choose a supplier within the “Call List” section 54, the shop user will select a “Request a Quote” check box 56 and determine the method of payment for the part in a “Charge to” section 58. As a preferred supplier, if the shop user has an account set up with the supplier, the “Supplier Account” box will be selected. Otherwise, the “Credit Card” box will be selected. The shop user verifies the method of payment and selects the appropriate box.

Referring to FIG. 2c, once a supplier user to the system successfully logs on, the user is directed to an entry screen 60 having a screen tool bar 62 divided into various sections. A “View RFQs” section 64 displays the RFQs that have been received from the shop user. A “View Quotes” section 66 displays the quotes that have been submitted. A “View Orders” section 68 displays the orders that have been placed. A “Returned Parts” section 70 provides the supplier the ability to respond to the shop's request to refer to returned defective/unused parts. A “My Info” section 72 displays the supplier user's personal information and allows the supplier user to update personal information and passwords. A “Help” section 74 provides assistance in navigating through the website. A “Log Out” section 76 logs the supplier user out of the system.

The entry section 60 is provided with an “Account Status” section 78. The “Account Status” section 78 provides the supplier user with the following types of information: open RFQs, orders to deliver, pending returns, new messages, and the like.

The website entry screen 60 allows the supplier user to create a quote for a vehicle part submitted by the shop user. To create a quote, the supplier user must fill in the following fields: “the supplier part number” 80 which is the number identifying the part; “the brand of the part” 82—the manufacturer of the part; “list price” 84—manufacturer's suggested price; “cost” 86—the dollar amount the supplier user is willing to sell the part for; “quote charge” 88—the amount refunded when the defective part is returned; “delivery” 90—the amount of time it will take for the supplier user to deliver the part and if the delivery is going to be picked up by the shop, then the supplier user will call the shop for the delivery time; and “warranty” 92—the guarantee given to the supplier from the shop stating that a product is reliable and free from known defects and that the supplier will, without charge, repair or replace defective parts within the given time limit specified. Once all fields are completed for the RFQ, the “Quote Box” 94 is selected to submit the RFQ to the shop user.

Messages can be sent back and forth between shops and suppliers to clarify RFQs. As shown in FIG. 2c, the supplier user can select the “Ask Shop a Question” box 96 to ask a question of the shop. Referring to FIG. 2d, an entry screen 100 constructed in accordance with the present invention is shown. The entry screen 100 is an example of an entry screen as presented on the website to a supplier user for asking a question to the shop. The supplier user enters a question in a “Question” section 102 at the bottom of the screen. Once the question is completed, the supplier user selects an “Ask a Question” box 104 and the question is submitted to the shop user. The supplier user receives confirmation that the question has been recorded. The shop user receives the question and replies.

Referring to FIG. 2e, the shop user selects the “View Orders” section 38 and a website screen 110 is provided which allows a shop user to accept a quote from the supplier user for the part type. To accept a quote, the shop user selects the desired order from the order section 112. To accept a quote, the shop user selects an “Order”. After selecting the “Order”, the quote is accepted and the part is purchased according to the selected method of payment. If the shop user has a question for the selected supplier about the part type, the shop user may ask selected suppliers a question. The shop user selects “Ask Suppliers Question” 114.

Referring to FIG. 2f, an entry screen 120 constructed in accordance with the present invention is shown. The entry screen 120 is provided with a “Question” section 122 which is opened once the “Ask Suppliers Question” 114 is selected. The “Question” section 122 allows the shop user to ask a question of the supplier. Once the shop user is finished entering the question in the box, the “Ask a Question” box 124 is selected and a question/response to the supplier user in regard to the RFQ is submitted.

Referring to FIG. 2g, a website screen is shown as presented on the website for a shop user to return a part. If a need arises to return a part or core, the return parts section 40 is selected. This allows a shop user to send an inquiry to the supplier user to obtain approval to return the part or core. It should be understood by one of ordinary skill in the art that though the example of the website is shown as managing the buying and selling of automobile parts, the website may be used to manage the buying and selling of any goods or service.

In one preferred embodiment, the “Host” system 12 is used to facilitate local transactions, i.e., transactions between registered buyers and registered sellers who are located within 100 miles or less of each other, for example. In this regard, the “Host” system 12 has the ability to limit the number of registered sellers a registered buyer of the shop system 14 can select by localizing the region in an area to be serviced by the registered seller. The “Host” system 12 can localize the region by zip code, state, region, or a fixed or selected radius.

Attached hereto are various materials illustrating and describing the operation of one preferred embodiment of the present invention. It should be understood that changes may be made in the operation and the setup of such embodiment.

The shop system 14 and the seller systems 16 are preferably web-enabled devices capable of communicating with the shop system 14 via a web-browser. However, it should be understood that innovation occurs very quickly in this technological area. Therefore, it should be understood that the shop systems 14 and the seller systems 16.

Changes may be made in the combinations, operations, and arrangements of the various parts and elements described herein without departing from the spirit and the scope of the invention as defined in the following claims.

1. An exchange system for managing the buying and selling of goods and services between registered buyers and registered sellers, comprising:
a host system, established as a website on the Internet, capable of selectively receiving, storing, and transmitting information representative of buying and selling of the goods and services;
a plurality of shop systems remotely located from the host system and in communication with the host system, each of the plurality of shop systems being associated with a registered buyer and capable of inputting a request for quotation into the host system and a list of selected ones of the registered sellers whereby the host system delivers the request for quotation to the registered sellers selected by the buyer submitting the request for quotation; and
a plurality of supplier systems remotely located from the host system and in communication with the host system, each of the plurality of supplier systems being associated with a registered seller and receiving the request for quotation on the registered seller's behalf, each supplier system capable of receiving the request for quotation and submitting the quotation to the host system.

2. The exchange system of claim 1 wherein the request for quotation is assigned a unique tracking code by the host system and wherein the host system stores and transmits the request for quotation.

3. The exchange system of claim 2 wherein the request for quotation includes at least one of a year, a make, a model, an engine, and a vehicle identification number of an automotive vehicle, an automotive part type, and a quantity of the automotive part.

4. The exchange system of claim 3 wherein each of the plurality of shop systems is capable of canceling the request for quotation.

5. The exchange system of claim 1 wherein the quotation is received by the host system and wherein the host system stores and transmits the quotation.

6. The exchange system of claim 5 wherein the quotation created by each of the plurality of supplier systems includes a supplier part number, a brand, a list price, a cost, a core charge, a delivery time, and a warranty.

7. The exchange system of claim 5 wherein each of the supplier systems are capable of retracting the quotation.

8. The exchange system of claim 1 wherein each of the plurality of shop systems accepts the quotation submitted by one of the plurality of supplier systems and purchases an automotive part and places an order with the supplier.

9. The exchange system of claim 1 wherein the host system is capable of communicating the request for quotation with the supplier systems by electronic mail, phone, fax, numeric pager, text messaging, and wireless phone.

10. The exchange system of claim 1 wherein the host system transmits a notification to the registered supplier by a notification system separate from the supplier system.

11. The exchange system of claim 10 wherein the notification system is designated by the registered seller.

12. A method for managing the buying and selling of goods and services between registered buyers and registered sellers, the method comprising the steps of:
receiving a request for quotation, by a host system established as a website on the Internet, from a plurality of shop systems remotely located from the host system and in communication with the host system, each of the plurality of shop systems being associated with a registered buyer;
generating a unique tracking code, by the host system, identifying the request for quotation;
storing the request for quotation including the unique tracking code identifying the request for quotation;
transmitting the request for quotation, by the host system, to a plurality of supplier systems remotely located from the host system and in communication with the host system, each of the plurality of supplier systems being associated with a registered seller;
receiving a quotation, by the host system, from the plurality of supplier systems; and
transmitting the quotation, by the host system, to the plurality of shop systems.

13. The method of claim 12 wherein the request for quotation includes at least one of a year, a make, a model, an engine, and a vehicle identification number of an automotive vehicle, an automotive part type, and a quantity of the automotive part.

14. The method of claim 12 wherein the quotation created by each of the plurality of supplier systems includes a supplier part number, a brand, a list price, a cost, a core charge, a delivery time, and a warranty.

15. The method of claim 12 wherein each of the supplier systems are capable of retracting the quotation.

16. The method of claim 12 wherein each of the plurality of shop systems accepts the quotation submitted by one of the plurality of supplier systems and purchases an automotive part and places an order with the supplier.

17. The method of claim 12 wherein the host system is capable of communicating the request for quotation with the supplier systems by electronic mail, phone, fax, numeric pager, text messaging, and wireless phone.

18. The method of claim 12 wherein the host system transmits a notification to the registered supplier by a notification system separate from the supplier system.

19. The method of claim 19 wherein the notification system is designated by the registered seller.
